(19) United States
(12) Patent Application Publication
(10) Pub. No.: US 2005/0276643 A1
(43) Pub. Date: Dec. 15, 2005

(54) PRINT SYSTEM WITH IMPROVED PRINT QUALITY

(76) Inventor: Yen-Sung Hsieh, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/908,702

(22) Filed: May 23, 2005

(30) Foreign Application Priority Data
Jun. 9, 2004 (TW) 093116607

(51) Int. Cl. B41J 13/03

(52) U.S. Cl. 400/48; 400/23; 400/637

(57) ABSTRACT

A print system includes a horizontal print platform for supporting a print medium, and a discharge roller installed on a first side of the print platform in a rotatable manner for discharging the print medium from a print area. The top of the discharge roller is higher than the platform. The print system further includes a discharge pressure roller for providing a force to the print medium. The center of the discharge pressure roller is horizontally positioned between the center of the discharge roller and the print area and is higher than the center of the discharge roller. The bottom of the discharge pressure roller is lower than the top of the discharge roller and is higher than the platform.

### BACKGROUND OF INVENTION

1. Field of the Invention

The present invention relates to a printer system, and more specifically, to a printer system capable of printing to an entire surface of a print medium with improved print quality.

2. Description of the Prior Art

Printers capable of printing to an entire surface of a print medium can print photos with quality near to those developed by a photo studio. Please refer to FIG. 1 and FIG. 2. FIG. 1 and FIG. 2 are diagrams of a conventional printer 10. The printer 10 includes a pickup roller 12, a tray 14, a feed roller 16, a feed pressure roller 18, a discharge roller 20, a discharge pressure roller 22, a print platform 24, and a print head 26. As shown in FIG. 1, the pickup roller 12 picks up paper 28 from the tray 14 to the print platform 24 in a rotation direction 30 for printing images or words on the paper 28. The feed roller 16 and the feed pressure roller 18 provide a proper clamping force F to the paper 28 for feeding the paper 28 precisely in a rotation direction 32. As shown in FIG. 2, when the print head 26 prints the end of the paper 28, the print head 26 cannot print the section within the distance d of the paper 28 very well, wherein the distance d is the distance between a last print point 50 and a clamp point 51 of the feed roller 16 and the feed pressure roller 18. This is because when the feed roller 16 and the feed pressure roller 18 release the paper 28 at the clamp point 51, the motion of the paper 28 is controlled by the discharge roller 20. Hence, the discharge roller 20 has not only the function of discharging the printed paper from a print area but also the function of controlling the precise motion of the paper 28 after the paper 28 leaves the clamp point 51. If the discharge roller 20 cannot control the motion of the paper 28 precisely after the paper 28 leaves the clamp point 51, the print quality will be decreased. In typical printers employing the discharge roller 20 and the discharge pressure roller 22, due to the weight of the paper 28, after the paper 28 leaves the clamp point 51, the end of the paper 28 will rise.

Please refer to FIG. 3. FIG. 3 is a diagram showing the end of the paper 28 rising within a print area L. At this time, if the print head 26 does not print the end of the paper 28, the paper will be discharged out of the print 10 by the discharge roller 20. On the other hand, if the print head 26 continues printing the end of the paper 28, the end of the paper may rise to be nearer or even to contact the print head 26, within the print area L so that distances h1, h2 between the print head 26 and the paper 28 are not equal and, in fact, unstable.

Please refer to FIG. 4. FIG. 4 is a diagram showing a first solution for the above problem of the printer 10. To prevent the end of the paper 28 from rising, a second discharge pressure roller 221 is utilized to apply a force P for leveling the end of the paper 28 so as to ensure a distance h between the print head 26 and the paper 28 within the print area L is constant and stable for maintaining the print quality. However, the first solution including of the second discharge pressure roller 221 will increase the complexity and cost of the printer 28, and increase the possibility of the surface of the paper 28 being damaged by the second discharge pressure roller 221.

Please refer to FIG. 5. FIG. 5 is a diagram showing a second solution for the above problem of the printer 10. To prevent the end of the paper 28 from rising, a second discharge roller 201 is positioned to the rear of the discharge roller 20, and the second discharge roller 201 is a little higher than the discharge roller 20. The increasing height of the paper 28 by the second discharge roller 201 ensures the paper 28 can stay close to the print platform 24 within the print area L and the distance h between the print head 26 and the paper 28 within the print area L is constant and stable for maintaining the print quality. However, the second solution will also increase the complexity and cost with the second discharge roller 201, and broaden a footprint of the printer 10.

### SUMMARY OF INVENTION

It is therefore a primary objective of the claimed invention to provide a printer system capable of printing to an entire surface of a print medium with improved print quality.

According to the claimed invention, a print system includes a horizontal print platform for supporting a print medium, and a discharge roller installed on a first side of the print platform in a rotatable manner for discharging the print medium from a print area. The top of the discharge roller is higher than the platform. The print system further includes a discharge pressure roller for providing a force to the print medium. The center of the discharge pressure roller is horizontally positioned between the center of the discharge roller and the print area and is higher than the center of the discharge roller. The bottom of the discharge pressure roller is lower than the top of the discharge roller and is higher than the platform.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 and FIG. 2 are diagrams of a conventional printer.

FIG. 3 is a diagram showing the end of paper rising within a print area L in the printer of FIG. 1.

FIG. 4 is a diagram showing a first solution for the paper-rising problem of the printer of FIG. 1.

FIG. 5 is a diagram showing a second solution for the paper-rising problem of the printer of FIG. 1.

FIG. 6 is a diagram of a print system of the present invention.

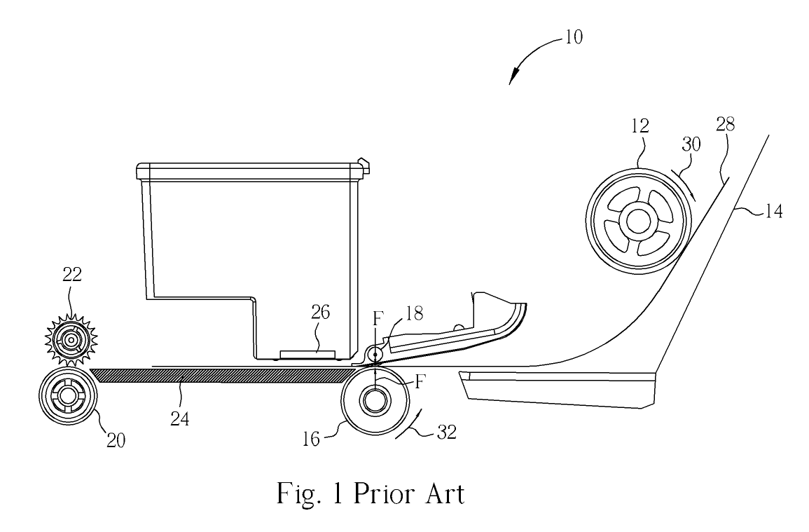

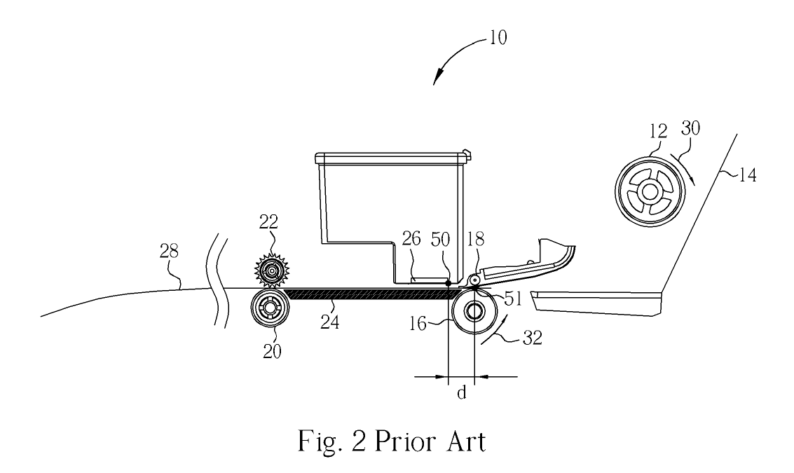

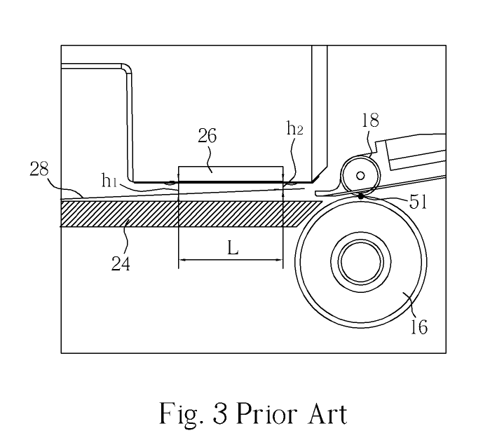

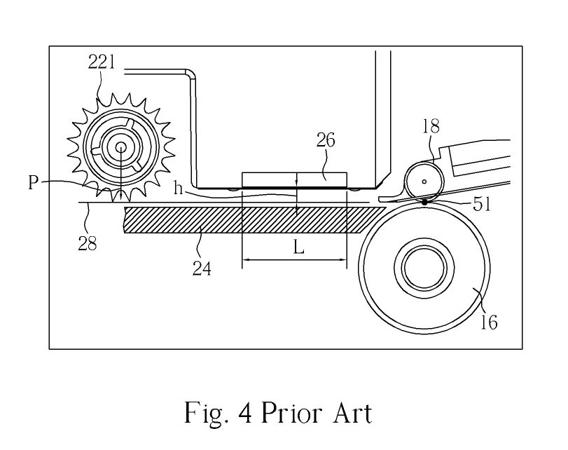

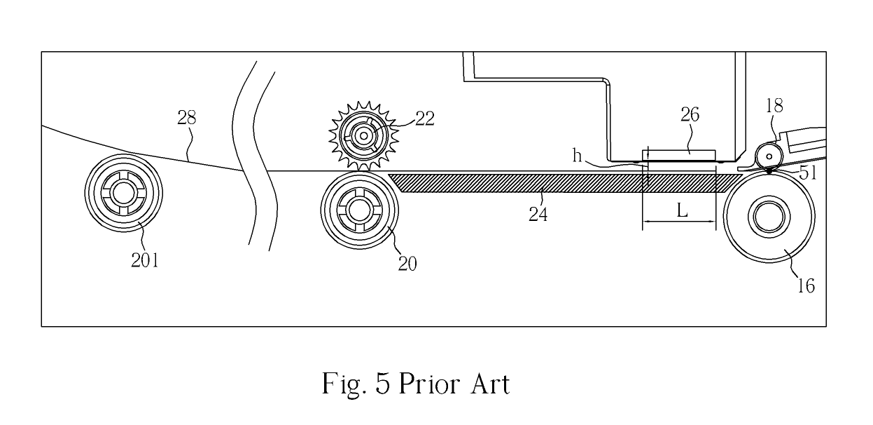

### DETAILED DESCRIPTION

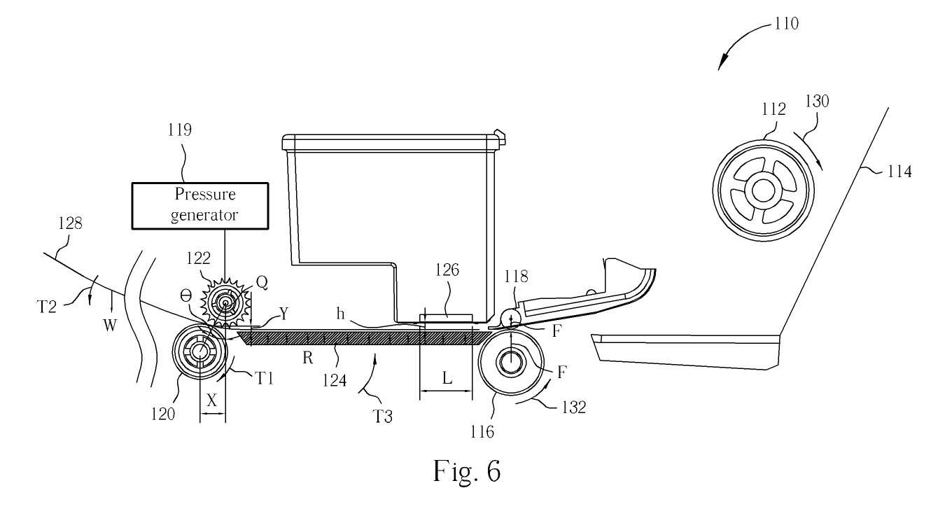

Please refer to FIG. 6. FIG. 6 is a diagram of a print system 110 of the present invention. The print system 110 can be a print system capable of printing to an entire surface (e.g. page) of a print medium (e.g. photo card stock). The print system 110 includes a pickup roller 112, a tray 114, a feed roller 116, a feed pressure roller 118, a discharge roller 130, a discharge pressure roller 122, a horizontal print platform 124, and a print head 126. As shown in FIG. 6, the pickup roller 112 transfers a print medium 128 from the tray 114 to the print platform 124 in a rotation direction 130 for printing images or words onto the print medium 128. The feed roller 116 and the feed pressure roller 118 provide a proper clamping force F to the print medium 128 for feeding the print medium 128 precisely in a rotation direction 132. The print medium 128 can be paper.

The discharge roller 120 is installed on a first side of the print platform 124 in a rotatable manner, and the top of the discharge roller 120 is higher than the print platform 124. The contact surface of the discharge roller 120 and the print medium 128 is higher than the print platform 124 by a vertical distance Y. The discharge roller 120 can discharge the printed print medium 128 from a print area L. The discharge pressure roller 122 can provide a force Q to the print medium 128, and the force Q can be generated by a pressure generator 119 and be outputted to the discharge pressure roller 122. The pressure generator 119 can be an elastic element for outputting elastic force to the discharge pressure roller 112. The center of the discharge pressure roller 122 is horizontally positioned between the center of the discharge roller 120 and the print area L and is higher than the center of the discharge roller 120, and the bottom of the discharge pressure roller 122 is lower than the top of the discharge roller 120 and is higher than the print platform 124. That is, the contact surface of the discharge pressure roller 122 and the print medium 128 is higher than the print platform 124. The distance between the center of the discharge roller 120 and the center of the discharge pressure roller 122 is X in the horizontal.

The tray 114 can support the unprinted print medium 128, and the pickup roller 112 is installed above the tray 114 in a rotatable manner for transferring the print medium 128 from the tray 114 to the print platform 124 in a rotation direction 130. The feed roller 116 and the feed pressure roller 118 are installed on a second side of the print platform 124 for holding the print medium 128 when the print medium 128 is printed by the print head 126 and for feeding the print medium 128 to the discharge roller 120 and the discharge pressure roller 122.

The force Q applied to the print medium 128 by the discharge pressure roller 122 can provide a clockwise moment T1 (T1=Q*X) to the print medium 128. When the moment T1 is greater than the counterclockwise moment T2 applied to the print medium 128 by the weight of the print medium 128, the print medium 128 stays close to the print platform 124 due to the rigidity of the print medium 128. At the same time, the print platform can apply a distributed force R to the reverse side of the print medium 128 so as to ensure a distance h between the print head 126 and the print medium 128 is constant and stable for maintaining the print quality. Additionally, the print medium 128 can be constrained on the print platform 124 levelly so that the discharge roller 120 can discharge the print medium 128 smoothly. That is, in the moment equilibrium of the print medium 128, the clockwise moment T1 by the force Q is equal to the sum of the counterclockwise moment T2 by the weight w of the print medium 128 and the counterclockwise moment T3 by the distributed force R (T1=T2+T3) by taking the center of the discharge roller 120 as a fulcrum.

The horizontal distance X between the discharge pressure roller 122 and the discharge roller 120, the perpendicular distance Y between the contact surface of the discharge roller 120 and the print medium 128 and the print platform 124, and the force Q provided by the discharge pressure roller 122 are important parameters in the present invention. Generally, the weight of a piece of A4 photo paper is from 11 g to 16 g, and if the outer diameter of the discharge pressure roller 122 is 10 mm, it is proposed that X should be from 4 mm to 5 mm. In addition, an angle (theta) between a line connecting the center of the discharge pressure roller 122 and the center of the discharge roller 120 and a vertical line is from 20 to 45 degrees.

A main characteristic of the present invention is that the distance h between the print head 126 and the print medium 128 within the print area L is constant and stable for maintaining the print quality through the arrangement of the above-mentioned components. Because the contact surface of the discharge roller 120 and the print medium 128 is higher than the print platform 124 and the center of the discharge pressure roller 122 is between the center of the discharge roller 120 and the print area L (offsetting the discharge pressure roller 122 from the discharge roller 120), a proper couple can be applied to the print medium 128. The print medium 128 can be level in the print area L due to the moment equilibrium of the couple and the force Q applied to the print medium 128 by the discharge pressure roller 122. Therefore, there is no need to include additional components in the print system 110 of the present invention, and the distance h between the print head 126 and the print medium 128 within the print area L is constant and stable. In addition, the bottom of the discharge pressure roller 122 needs to be positioned above the print platform 124 for preventing the print medium 128 from being lower than the print platform 124 and causing the print medium 128 to rise within the print area L.

The discharge pressure roller 122 can have a surface that prevents smudging a print element printed onto the print medium 128 so that the discharge pressure roller 122 does not affect print quality when applying the force Q to the print medium 128. The print element can be ink or carbon powder.

Compared to the conventional print system, there is no need to add more print components to the print system of the present invention, and the distance between the print head and the print medium within the print area is kept constant and stable so as to maintain the print quality when printing to the entire surface of the print medium. The problem of poor print quality to the end of the print medium is reduced so that printing costs can be decreased. In addition, the print medium can be constrained on the print platform levelly so that the discharge roller can discharge the print medium smoothly for reducing the possibility of a paper jam.

Those skilled in the art will readily observe that numerous modifications and alterations of the device may be made while retaining the teachings of the invention. Accordingly, the above disclosure should be construed as limited only by the metes and bounds of the appended claims.

1. A print system comprising:
a horizontal print platform for supporting a print medium;
a discharge roller installed on a first side of the print platform in a rotatable manner, a top of the discharge roller being higher than the print platform, for discharging the print medium from a print area; and
a discharge pressure roller for providing a force to the print medium, a center of the discharge pressure roller being horizontally positioned between a center of the discharge roller and the print area and being higher than the center of the discharge roller, and a bottom of the discharge pressure roller being lower than the top of the discharge roller and being higher than the print platform.

2. The print system of claim 1 further comprising a pressure generator for outputting force to the discharge pressure roller.

3. The print system of claim 2 wherein the pressure generator is an elastic element for outputting elastic force to the discharge pressure roller.

4. The print system of claim 1 further comprising a feed roller and a feed pressure roller installed on a second side of the print platform for holding the print medium when the print medium is printed and for feeding the print medium to the discharge roller and the discharge pressure roller.

5. The print system of claim 1 further comprising a tray for supporting unprinted print medium, and a pickup roller installed above the tray in a rotatable manner for transferring the print medium from the tray to the print platform.

6. The print system of claim 1 wherein a horizontal distance between the center of the discharge pressure roller and the center of the discharge roller is from 1 to 2 mm.

7. The print system of claim 1 wherein a distance between the top of the discharge roller and the print platform is from 4 to 5 mm.

8. The print system of claim 1 wherein an angle between a line connecting the center of the discharge pressure roller and the center of the discharge roller and a vertical line is from 20 to 45 degrees.

9. The print system of claim 1 wherein a surface of the discharge pressure roller prevents smudging of a print element printed on the print medium.

10. The print system of claim 9 wherein the print element is ink.

11. The print system of claim 9 wherein the print element is carbon powder.

12. The print system of claim 1 wherein the print system is a print system capable of printing to an entire surface of the print medium.
